(19) United States
(12) Patent Application Publication
(10) Pub. No.: US 2013/0168931 A1
(43) Pub. Date: Jul. 4, 2013

(54) Indoor Walker

(71) Applicant: Peter Baraitaru, Bottingen (DE)

(72) Inventor: Peter Baraitaru, Bottingen (DE)

(21) Appl. No.: 13/726,807

(22) Filed: Dec. 26, 2012

(30) Foreign Application Priority Data
Dec. 30, 2011 (DE) 10 2011 057 181.7

(51) Int. Cl. A61H 3/04

(52) U.S. Cl. CPC A61H 3/04
USPC 280/30

(57) ABSTRACT

A walker includes a chassis; at least one handle connected with the chassis and adapted for moving the walker by a user; and at least three roller means attached to the chassis and on which the walker is moved on a surface. The walker is adapted so that it may be converted from a roll configuration, in which a user may push the walker in order to support himself thereon, into a sit configuration, in which the user may sit down on a sitting means, wherein the sitting means comprises a front seat element and a rear seat element, which formed in the sit configuration a sitting area, and wherein the front seat element moves with respect to the rear seat element, if the sitting means is moved from the sit configuration to the roll configuration.

### CROSS-REFERENCE TO RELATED APPLICATION(S)

This application claims the benefit of German Patent Application No. 10 2011 057 181.7, filed Dec. 30, 2011, the entirety of which is hereby incorporated herein by reference.

### BACKGROUND OF THE INVENTION

1. Field of the Invention

The present invention relates to an indoor walker and an indoor mobility aid, respectively.

2. Description of the Related Art

Known walkers generally comprise four wheels arranged on a rigid frame. The front wheels are generally arranged pivotively. Handles are attached to the frames allowing a user to be supported by the frame and to push the walker in front of himself. Generally, walkers are mainly used by elderly people, but they may also be used by younger people for purposes of rehabilitation, such as in case of severe injuries.

Conventional walkers are not suitable for indoor use.

Therefore, there is a need for a walker suitable for indoor use.

### SUMMARY OF THE INVENTION

The disadvantages of the prior art are overcome by the present invention which, in one aspect, is a walker including at least one chassis, at least one handle connected to the chassis and adapted for moving the walker by the user, and at least three roller means attached to the chassis and by which the walker is moved on a surface. The roller means are arranged such that the center of gravity of the user is located between the roller means, when the user moves the walker by the handle in the front direction. The walker comprises a portion being open in the rolling direction through which the user may pass. The user may support himself on the handle.

Two rear roller means arranged at the rear of the walker may be attached pivotally to the chassis. All roller means, i.e. the front roller means and the rear roller means may be pivoted about 360°. Thereby, it may be achieved that the walker may be turned on the spot, which is of particular importance indoors.

On each of the two rear roller means and the wheels thereof, respectively a brake may act. A blocking means may be provided blocking the rear roller means such that a pivoting movement of the rear roller means with respect to the chassis is prevented. Preferably, the brake is provided by an element being moved coaxially with respect to the pivoting axis of the rear roller means and that prevents a pivoting movement of the rear roller means and a turning movement of the roller means, if the element is moved into the engaging position. A buffer may be provided which is pressed against the floor on which the roller means are moved in order to prevent that the walker may be moved and/or the roller means may be pivoted. The buffer may be elastically.

On the handle or on the hand support an operation element for the brake, such as a fixing brake, may be arranged for operating the brake that acts on the rear roller means, and the operation element operates the blocking means for preventing a pivoting movement of the rear roller means with respect to the chassis. The operating means for the brake may also operate the buffer as a brake and/or fixing brake.

An automatic break operating means may be provided acting on the break and blocking means as soon as a user supports himself on a supporting means, such as in a sitting position and/or leaning position.

The walker may be adapted such that it may be converted from a roll configuration, in which a user may push the walker to support himself thereon, into a sitting configuration, in which the user can sit down on a sitting means. The sitting means may comprise a front seat element and a rear seat element forming a sitting area in the sitting configuration. The front seat element may be moved with respect to the rear seat element, when the sitting means is moved from the sitting configuration into the rolling configuration. The front seat element may be pivoted with respect to the rear seat element, when the sitting means is moved from the sitting configuration into the rolling configuration. The front seat element and the rear seat element do not have to be coupled by a hinge. It is sufficient that an arbitrary element may be provided resulting in a pivoting movement, when the sitting element is moved from the rolling configuration into the sitting configuration or vice versa.

The rear seat element may form in the rolling configuration a buttocks supporting device in the sense of a cower means on which a user may support his buttocks. The rear seat element may be located in the roll configuration above the front seat element. The rear seat element can be located in the roll configuration in an angular range of approximately +/−22°, preferably approximately +/−10° with respect to the horizontal axis. The front seat element can be located in the roll configuration in an angular range of approximately +/−20°, preferable approximately +/−10° with respect to the vertical axis. Thereby, it is achieved that the front seat element of the sitting means is located comparably space saving in the roll configuration. Further, the user is provided with an additional cower means on which he may cower during pushing the walker in order to make a pause and/or to recover strength.

Further, the user may support himself on the cower means, if he wants to grab an object from a shelf, cupboard or the like or if he wants to open a room door or cupboard door.

Further, the user can support his body in the roll configuration at the front seat element. Depending on the configuration of the walker, the user may support the lower part of his body or the upper part of his body on the seat element.

The rear seat element may be connected rigidly with the handles by which the user may push the walker in the roll configuration. A backrest may be connected rigidly with the handles and rear seat element. The rear seat element, backrest and handles may be formed integral (by one-piece). Further, the walker may be configured such that the rear seat element is not moved with respect to the handles during converting the walker from the sit configuration in to the roll configuration. Thereby, a particular stable and simple configuration of the walker is achieved. Further the buttocks of the user is lifted by the rear seat element during converting the walker from the sit configuration to the roll configuration such that the user can lift himself more swiftly from a sitting position to a standing position.

The walker may comprise a slider element that is movable with respect to the chassis of the walker. The rear seat element may be arranged at the slider element. Further, handles may be arranged at the slider element. The expression “slider element” has to be interpreted such that it comprises an arbitrary element movable with respect to the chassis of the walker. Preferably the slider element is a U-shaped bracket on which the rear seat element and handles are located. The slider element may be movable with respect to the frame tubes of the chassis. Particularly, the U-shaped carrier forming the slider element may be movable with respect to the supporting tubes of the chassis.

On the slider element an actor may be arranged. The actor may be a spring or an electric motor, for example. The actor may provide a force for moving the slider element with respect to the chassis.

On the chassis a gearing may be located, wherein the actor drives a gear engaging the gearing arranged on the chassis. Preferably the actor may drive the gear by a spindle gear or a planetary gear. On the one hand, a high speed reduction is achieved thereby and on the other hand it is ensured that the slider may not move due to the force exerted by the user.

The walker may comprise a height fixing means adapted to adjustably fix the height of the cower position of a user in the rolling configuration.

The height, in which the rear seat element is located in the rolling configuration may be adapted to the requirements of the user, such as the size of the user. A movable switching means or a cam may be provided ensuring that the electric motor may only move the rear seat element to a particular height. The switching means or the cam may be arranged on the slider means or on the chassis. If the switching means or the cam is arranged on the slider means a movable trigger element may be arranged on the chassis. If the switching means or the cam contacts the trigger means, the switching means or the cam causes that the motor does not move the rear seat element further upwards.

It is also possible to provide a movable mechanical stop, which causes that the rear seat element may be lifted only to a particular height. The stop, the switching means and/or the cam act as a height fixing means.

The walker according to the present invention comprises a supporting means and a sitting means, respectively which allow in its sitting configuration a user to sit on the sitting area formed thereby over a longer period. Accordingly, the walker generates in the optical impression of a chair. In the rolling configuration the sitting means has the function of a cower aid on which the user may cower over a more or less shorter period, when he wants to take a rest or if he wants to have at least one hand not on the walker, such as when he wants to take an object from a shelf, operate an equipment or the like.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

The invention is described below under reference to the accompanying drawings in more detail, wherein the description is intended for the sake of explanation offered embodiment and is not to be construed limiting.

FIG. 1 shows a side view of the walker according to the present invention.

FIG. 2 shows a front view of the walker according to the present invention.

FIG. 3 shows a perspective view of the walker according to the present invention.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

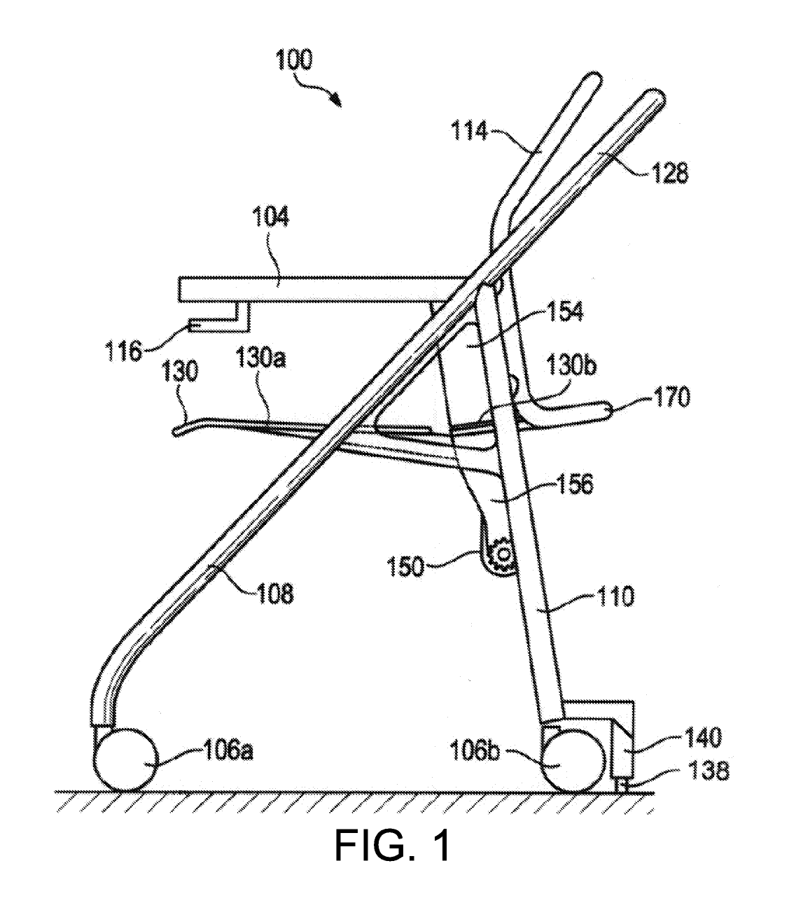

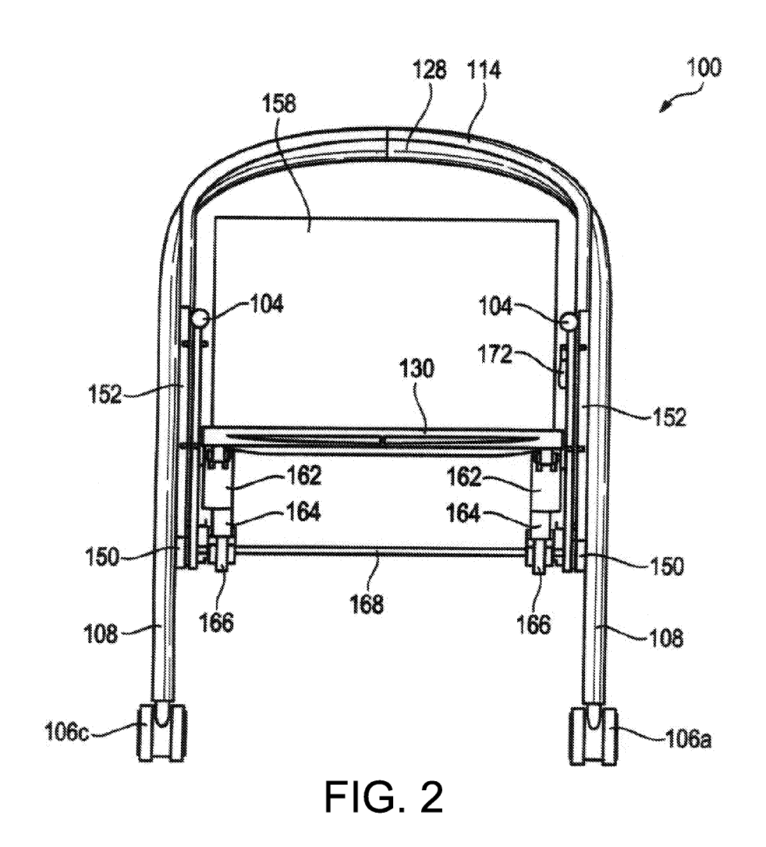

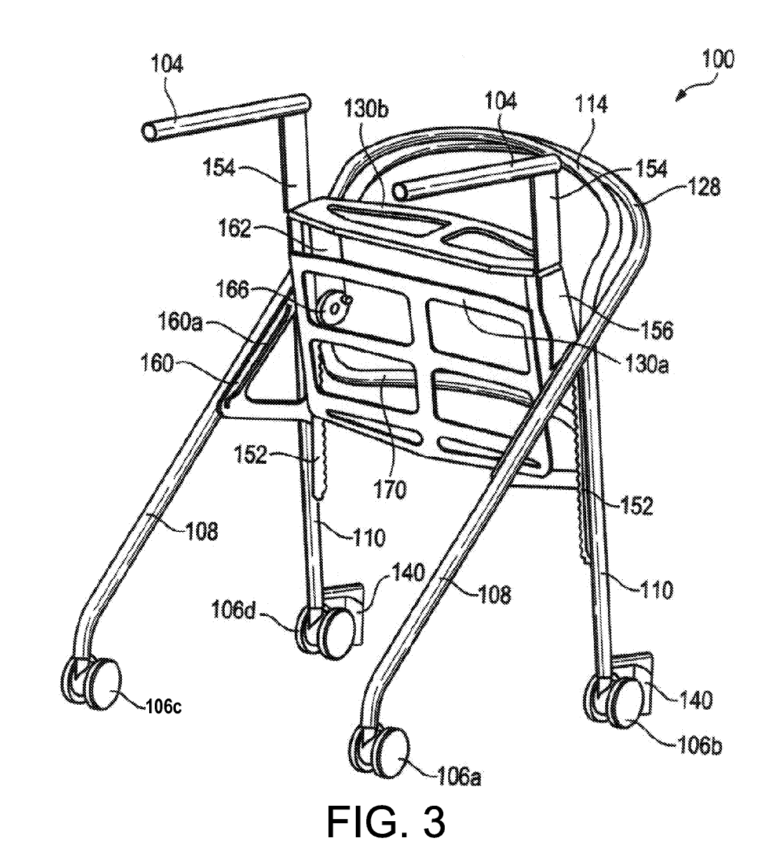

Under reference to FIGS. 1, 2 and 3 a walker according to the present invention is described. FIG. 1 shows a side view, FIG. 2 shows a front view and FIG. 3 shows a perspective view of the walker according to the present invention. In FIGS. 1 and 2 the inventive walker 100 is shown in its sitting configuration. In FIG. 3 the inventive walker 100 is shown in its roll configuration.

The walker and walking aid 100, respectively is shown in FIGS. 1 and 2 as a chair and may be used by a user as a chair. The walker comprises a sitting means 130 having a front seat element 130a and a rear seat element 130b. The seat element is fastened at a front bracket 108 and a rear bracket 110. On the right front bracket 108 a right front roller means 160a is attached. On the left front carrier 108 a left front roller means 106c is attached. At the right rear bracket 110 a right rear roller means 106b is attached. On the left rear bracket 110 a left rear roller means 106d is attached.

The front roller means 106a and 106c may be attached pivotively at the front carrier 108. Alternatively or additionally the rear roller means 106b, 106d may be attached pivotively at the rear carriers 110. The front bracket 108 may be arranged pivotively with respect to the rear brackets 110 such that the walker 110 may be folded into a transport position. The front brackets 108 may be formed integral by connecting the same by means of a rear connecting tube 128. Also the rear brackets 110 may be formed integral by connecting them by a front connecting tube 140. Further, the walker comprises a backrest 158 on which a user may lean. The walker also comprises a reinforcement 170.

On a handle and armrest 104, respectively a brake operating element 116 is arranged. The brake operating element 116 operates by a Bowden cable, an electric connection or a hydraulic connection a breaking means 140. The breaking means 114 comprises a buffer 138. Once the brake operating element 116 is operated the buffer 138 is pressed against the floor, whereby a breaking action develops and the walker 100 is fixed in its position.

As mentioned before, the sitting means 130 comprises a front seat element 130a and a rear seat element 130b. In the sitting configuration shown in FIGS. 1 and 2 the front seat element 130a and the rear seat element 130b form a sitting area on which a user can sit down. It is to be understood that the front seat element 130a and the rear seat element 130b may be cushioned.

In the rolling configuration shown in FIG. 3 the rear seat element 130b is located essentially horizontal, such as within an angular range of +/−20°, preferably +/−10° with respect to the horizontal axis. Thus, a user may base (support) himself in the rolling configuration on the rear seat element 130b and compensate his body wait to make a rest during rolling the walker. Further, the user may cower on the rear seat element 130b, if he grabs an object from a shelf and/or opens a door, a cupboard door or a room door for example.

The front seat element 130a is located in the rolling configuration in an essentially vertical position, i.e. approximately +/−20°, preferably approximately +/−10° with respect to the vertical axis. The rear seat element 130b is fixed rigidly with an upper slider portion 154 on which also the handle 104 is fixed. The upper slider portion 154 is connected with a lower slider portion 156, which is guided with respect to the rear bracket in a guide (not shown). Further, the front seat element 130a is arranged pivotively on the lower slider portion 156. The front seat element 130a is arranged pivotively in a slot 160a formed in a bracket 160 attached to the front bracket 108. By the upward movement or downward movement of the rear slider portion 156 the front seat element 130 is pivoted from its essentially horizontal position in the sitting configuration in the essentially vertical position in the rolling configuration. The front end of the front seat element is pivoted backwards during the movement from the sitting configuration into the rolling configuration. In the rolling configuration the front end of the front seat element 130b is located under the rear end of the front seat element 130a.

It is important to note that the front seat element 130a and the rear seat element 130b may merely pivoted with respect to each other. The front seat element 130a and the rear seat element 130b do not have to be connected directly by a hinge or a pivoting means.

On the lower slider portion 156 a gear 150 is attached, that engages with a gearing 152 arranged on the rear carrier 110. At least one gear 150 may be arranged on a shaft 168. In the walker shown in FIGS. 1 to 3 on each side of the shaft 168 a gear 150 is arranged. The shaft synchronizes the right and left gear.

The shaft 168 is driven by at least one motor 162, such as an electric motor, by a planetary gear or a spindle gear 164 and a driving gear 166. In the walker shown in FIG. 2 on each side a motor 162, a gearing 164 and a driving gear 166 is provided. It is also possible to provide further motors 162, gearings 164 and driving gears 166 driving the drive shaft 168. Therefore, also user having a higher weight may be lifted or lowered.

The inventive walker also comprises a movable height definition means 172 adapted to define in which height the rear seat element 130b is to be located in the rolling configuration. The height definition means may be implemented by an electric switch which cuts the current supply to the motor 162 once the rear seat element 130b reaches its desired position.

The invention discloses a comparably light weight walker that may be used as a chair. A sitting portion of the walker may be pivoted such that a user may support himself thereon if he wants to take a rest during or after pushing the walker.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A walker, comprising:
(a) a chassis;
(b) at least one handle connected with the chassis and adapted for moving the walker by a user; and
(c) at least three roller means attached to the chassis and on which the walker is moved on a surface;
wherein the walker is adapted to convert from a roll configuration, in which a user may push the walker in order to support himself thereon, into a sit configuration, in which the user may sit down on a sitting means, wherein the sitting means comprises a front seat element and a rear seat element, which formed in the sit configuration a sitting area, and wherein the front seat element moves with respect to the rear seat element, if the sitting means is moved from the sit configuration to the roll configuration.

2. The Walker of claim 1, wherein the front seat element is pivotable with respect to the rear seat element, when the sitting means is moved from the sit configuration into the roll configuration.

3. The Walker of claim 1, wherein the rear seat element forms in the roll configuration a buttocks support means, on which the user may support his buttocks.

4. The Walker of claim 1, wherein the rear seat element is located in the roll configuration above the front seat element.

5. The Walker of claim 1, wherein the rear seat element is located in the roll configuration in an angle of approximately +/−20° with respect to the horizontal axis.

6. The Walker of claim 1, wherein the front seat element is located in the roll configuration under an angle of approximately +/−20° with respect to the vertical axis.

7. The Walker of claim 1, wherein the rear seat element is connected rigid with the at least one handle.

8. The Walker of claim 1, wherein the rear seat element is not moved during converting the walker from the sit configuration into the road configuration.

9. The Walker of claim 1, further comprising a slider element movable with respect to the chassis of the walker, wherein the rear seat element and the at least one handle are coupled with the slider element.

10. The Walker of claim 1, wherein on the slider element an actor is arranged.

11. The Walker of claim 1, wherein on the chassis a gearing is arranged and wherein the actor drives a gear engaging with the gearing of the chassis.

12. The Walker of claim 1, further comprising a height definition means adapted to adjustably define the height of a cower position in the roll configuration.
